(19) United States
(12) Patent Application Publication
(10) Pub. No.: US 2024/0221727 A1
(43) Pub. Date: Jul. 4, 2024

(54) VOICE RECOGNITION MODEL TRAINING METHOD, VOICE RECOGNITION METHOD, ELECTRONIC DEVICE, AND STORAGE MEDIUM

(71) Applicant: Beijing Baidu Netcom Science Technology Co., Ltd., Beijing (CN)

(72) Inventors: Lanhua YOU, Beijing (CN); Lei JIA, Beijing (CN); Qi ZHANG, Beijing (CN); Zhengxiang JIANG, Beijing (CN)

(21) Appl. No.: 18/266,432

(22) PCT Filed: Sep. 1, 2022
(86) PCT No.: PCT/CN2022/116552

§ 371 Date: Jun. 9, 2023

(30) Foreign Application Priority Data
Jun. 23, 2022 (CN) 202210719500.5

(51) Int. Cl. G10L 15/06; G10L 15/01; G10L 15/02; G10L 15/16

(52) U.S. Cl. CPC G10L 15/063; G10L 15/01; G10L 15/02; G10L 15/16

(57) ABSTRACT

The present disclosure provides a voice recognition model training method and apparatus, an electronic device and a storage medium, relating to the field of artificial intelligence technology, and in particular to the fields such as deep learning and voice recognition. The specific implementation scheme includes constructing a negative sample according to a positive sample to obtain a target negative sample for constraining a voice decoding path; obtaining training data according to the positive sample and the target negative sample; and training a first voice recognition model according to the training data to obtain a second voice recognition model.

### TECHNICAL FIELD

The present disclosure relates to the field of artificial intelligence technology, and in particular, to the fields such as deep learning and voice recognition.

### BACKGROUND

Voice recognition technology is a technology that allows a machine to transform a voice signal into corresponding text or command through recognizing and understanding processes. The voice recognition technology mainly includes feature extraction technology, pattern matching and other aspects. The current voice recognition is not accurate enough, which is a problem to be solved.

### SUMMARY

The present disclosure provides a voice recognition model training method and apparatus, a voice recognition method and apparatus, an electronic device and a storage medium.

According to one aspect of the present disclosure, provided is a voice recognition model training method, including constructing a negative sample according to a positive sample to obtain a target negative sample for constraining a voice decoding path; obtaining training data according to the positive sample and the target negative sample; and training a first voice recognition model according to the training data to obtain a second voice recognition model.

According to another aspect of the present disclosure, provided is a voice recognition method, including constraining a voice decoding path corresponding to voice data to be recognized according to a second voice recognition model in a case where the voice data to be recognized is being decoded, the second voice recognition model is a model trained according to the voice recognition model training method provided by embodiments of the present disclosure; and obtaining a voice recognition result according to the constraint on the voice decoding path, where the voice recognition result is a text object that matches expected text.

According to another aspect of the present disclosure, provided is a voice recognition model training apparatus, including a first processing module configured to construct a negative sample according to a positive sample to obtain a target negative sample for constraining a voice decoding path; a second processing module configured to obtain training data according to the positive sample and the target negative sample; and a training module configured to train a first voice recognition model according to the training data to obtain a second voice recognition model.

According to another aspect of the present disclosure, provided is a voice recognition apparatus, including a third processing module configured to constrain a voice decoding path corresponding to voice data to be recognized according to a second voice recognition model in a case where the voice data to be recognized is being decoded, the second voice recognition model is a model trained according to the voice recognition model training method provided by the embodiments of the present disclosure; and a fourth processing module configured to obtain a voice recognition result according to constraint on the voice decoding path, where the voice recognition result is a text object that matches expected text.

According to another aspect, provided is an electronic device, including: at least one processor; and a memory connected in communication with the at least one processor. The memory stores an instruction executable by the at least one processor, and the instruction, when executed by the at least one processor, enables the at least one processor to execute any method of embodiments of the present disclosure.

According to another aspect, provided is a non-transitory computer-readable storage medium storing a computer instruction thereon, and the computer instruction is used to cause a computer to execute any method of embodiments of the present disclosure.

According to another aspect of the present disclosure, provided is a computer program product including a computer program, and the computer program implements any method of embodiments of the present disclosure, when executed by a processor.

By adopting the present disclosure, the negative sample may be constructed according to the positive sample to obtain the target negative sample for constraining the voice decoding path, and the training data may be obtained according to the positive sample and the target negative sample. The second voice recognition model may be obtained by training the first voice recognition model based on the training data. Accuracy of voice recognition is improved since the second voice recognition model is obtained by training under the constraint on the voice decoding path.

It should be understood that the content described in this part is not intended to identify critical or essential features of the embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic diagram of a distributed cluster processing scenario according to the embodiments of the present disclosure.

FIG. 2 is a flow schematic diagram of a voice recognition model training method according to the embodiments of the present disclosure.

FIG. 3 is a schematic diagram of expensing a voice recognition path according to the embodiments of the present disclosure.

FIG. 4 is a schematic diagram of constraining a voice recognition path according to the embodiments of the present disclosure.

FIG. 5 is a schematic diagram of generating a prefix tree and samples according to the embodiments of the present disclosure.

FIG. 6 is a flow schematic diagram of a voice recognition method according to the embodiments of the present disclosure.

FIG. 7 is a schematic diagram of a network structure of a first composition model according to the embodiments of the present disclosure.

FIG. 8 is a schematic diagram of a network structure of a voice recognition model according to the embodiments of the present disclosure.

FIG. 9 is a schematic diagram of a voice recognition framework according to the embodiments of the present disclosure.

FIG. 10 is a schematic diagram of a composition structure of a voice recognition model training apparatus according to the embodiments of the present disclosure.

FIG. 11 is a schematic diagram of a composition structure of a voice recognition apparatus according to the embodiments of the present disclosure.

FIG. 12 is a block diagram of an electronic device for implementing a training method of a voice recognition model or a voice recognition method of a voice recognition model according to the embodiments of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope and spirit of the present disclosure. Likewise, for clarity and conciseness, descriptions of well-known functions and structures are omitted in the following descriptions.

The term “and/or” herein only describes an association relation of associated objects, which indicates that there may be three kinds of relations, for example, A and/or B may indicate that there is only A exists, or there are both A and B exist, or there is only B exists. The term “at least one” herein indicates any one of many items, or any combination of at least two of the many items, for example, at least one of A, B, or C may indicate any one or more elements selected from a set constituted of A, B, and C. The term “first” and “second” herein indicate a plurality of similar technical terms and use to distinguish them from each other, but do not limit an order of them or limit that there are only two items, for example, a first feature and a second feature indicate two types of features/two features, a quantity of the first feature may be one or more, and a quantity of the second feature may also be one or more.

In addition, in order to better illustrate the present disclosure, numerous specific details are given in the following specific implementations. Those having ordinary skill in the art should be understood that the present disclosure may be performed without certain specific details. In some examples, methods, means, elements and circuits well known to those having ordinary skill in the art are not described in detail, in order to highlight the subject matter of the present disclosure.

A voice signal may be converted into text and then outputted through voice recognition technology. With continuous development of deep learning technology in an acoustic model and a language model, the voice recognition technology has also made considerable progress. In terms of the acoustic model, it develops from the Gaussian Mixture Model-Hidden Markov Model (GMM-HMM) modeling method to the Streaming Multi-Layer Trancated Attention (SMLTA) model based on the Connectionist Temporal Classification (CTC) peak information, where the SMLTA model may provide an online voice recognition service based on an attention mechanism, which improves voice recognition performance. In terms of the language model, compared with an algorithm based on a statistical language model (e.g., a N-GRAM language model), a Neural Network Language Model (NNLM) generally has a better modeling ability for the text, is more suitable for parallel computing, also has a smaller volume of a saved model, and is especially suitable for an offline voice scenario such as address book recognition, since the NNLM is based on the deep learning technology. Therefore, the NNLM has more advantages in recognition effect, calculation speed and application scenario.

Different from the N-GRAM language model which has word graph constraint, all possible decoding paths will be expanded during a process of decoding by directly using the NNLM, and there is no mandatory constraint on the paths, which results in appearing of many unexpected texts, thereby introducing great recognition interference. Although the NNLM which is trained based on specific corpus may get higher language scores during voice recognition in relevant application scenarios, many unexpected recognition results (such as text out of the address book) also have high language scores.

In summary, because the decoding paths do not have the mandatory constraint on the paths, resulting in appearing of an unexpected recognition result, the voice recognition is not accurate enough.

According to the embodiments of the present disclosure, a voice recognition composition method based on a neural network constrains an extended path of a decoding space of the NNLM by training a voice recognition model (e.g., a composition model based on the neural network), thereby inhibiting output of the unexpected recognition result and effectively improving accuracy of the voice recognition.

According to the embodiments of the present disclosure, FIG. 1 is a schematic diagram of a distributed cluster processing scenario. The distributed cluster system is one example of a cluster system, FIG. 1 exemplarily describes that the distributed cluster system may be used to perform voice recognition. The present disclosure is not limited to the voice recognition on a single machine or multi-machines. Accuracy of the voice recognition may be further improved by adopting a distributed process. As shown in FIG. 1, the distributed cluster system 100 includes a plurality of nodes (e.g., a server cluster 101, a server 102, a server cluster 103, a server 104, and a server 105 which may also be connected to electronic devices, such as a mobile phone 1051 and a desktop computer 1052). One or more voice recognition tasks may be executed jointly among the plurality of nodes and between the plurality of nodes and the connected electronic devices. Alternatively, the plurality of nodes in the distributed cluster system may execute the voice recognition by adopting a data parallel relation, and the plurality of nodes may execute a voice recognition training task based on the same training manner. If the plurality of nodes in the distributed cluster system adopt a model parallel training manner, the plurality of nodes may execute the voice recognition training task based on different training manners to better train the above voice recognition model. Alternatively, data exchange (e.g., data synchronization) may be performed among the plurality of nodes after each round of relationship extraction model training is completed.

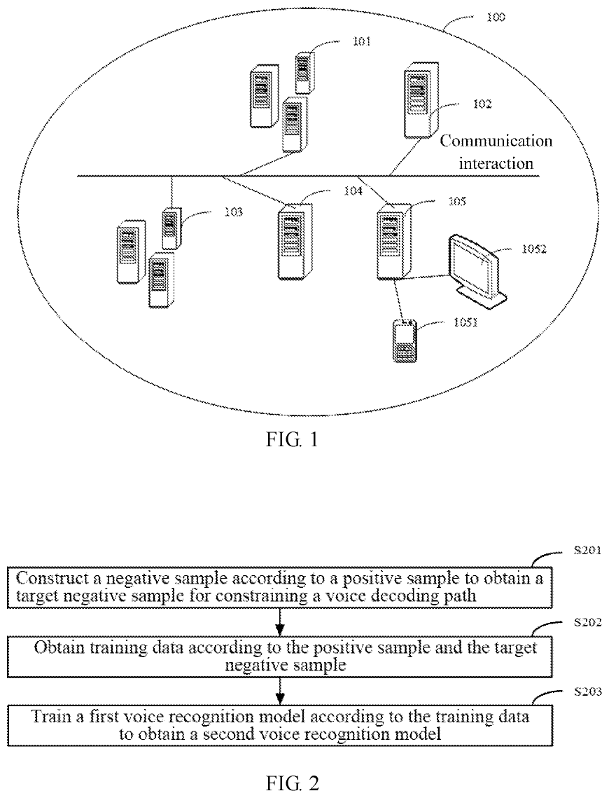

According to the embodiments of the present disclosure, a voice recognition model training method is provided, FIG. 2 is a flow schematic diagram of the voice recognition model training method according to the embodiments of the present disclosure. The method may be applied to a voice recognition apparatus. For example, the apparatus may realize the voice recognition and other processes in a case where the apparatus may be deployed in a terminal, a server or other processing devices in a single machine, multi-machines or the cluster system.

Where the terminal may be a User Equipment (UE), a mobile device, a Personal Digital Assistant (PDA), a handheld device, a computing device, an on-vehicle device, a wearable device and the like. In some possible implementations, the method may also be implemented in a manner that a processor calls a computer-readable instruction stored in a memory. As shown in FIG. 2, the method is applied to any node or electronic device (the mobile phone, the desktop or the like) in the cluster system shown in FIG. 1, and includes S201 to S203.

In S201, a negative sample is constructed according to a positive sample to obtain a target negative sample for constraining a voice decoding path.

In S202, training data is obtained according to the positive sample and the target negative sample.

In S203, a first voice recognition model is trained according to the training data to obtain a second voice recognition model.

In one example of S201-S203, a sample other than the positive sample may be taken as the target negative sample, and the positive sample and the target negative sample are used as the training data. Since the positive sample and the target negative sample correspond to data labels, supervised learning based on the data labels may be performed on the first voice recognition model, and the second voice recognition model may be obtained after model training is completed. The training data used for the model training includes the target negative sample that constrains the voice decoding path, that is, constraint for avoiding unexpected occurrence is made in advance, and then output of an unexpected voice recognition result (e.g., the text out of the address book in a voice scenario for the address book recognition) may be suppressed during a model training process and during a model using process, and thus the accuracy of the voice recognition is effectively improved.

By adopting the present disclosure, the negative sample may be constructed according to the positive sample to obtain the target negative sample for constraining the voice decoding path, and the training data may be obtained according to the positive sample and the target negative sample. The first voice recognition model may be trained according to the training data to obtain the second voice recognition model. The accuracy of the voice recognition is improved since the second voice recognition model is trained under the constraint on the voice decoding path.

In one implementation, constructing the negative sample according to the positive sample to obtain the target negative sample for constraining the voice decoding path includes determining a text character in a matching library as the positive sample; and determining the sample other than the positive sample as the target negative sample.

In some examples, the positive sample (as shown in TABLE 1) and the negative sample (as shown in TABLE 2) may form training sample. The training sample include several types of data, such as original text, a plurality of text characters that constitute the text, and tokens respectively corresponding to the plurality of text characters, and labels respectively corresponding to the plurality of text characters.

TABLE 1

| text | Start symbol <SOS> | Zhang | San |
|---|---|---|---|
| token | 3617 | 23 | 52 |
| label | 1 | 1 | 1 |

TABLE 2

| text | Start symbol <SOS> | Zhang | Dan |
|---|---|---|---|
| token | 3617 | 23 | 66 |
| label | 1 | 1 | 0 |

In some examples, the matching library may be a specified address book. For example, a user name “Zhang San” in the address book is taken as the positive sample, when one voice call involves the user name “Zhang San”, voice decoding is performed to obtain a correct voice recognition result which should be text information corresponding to the user name “Zhang San”. Accordingly, when designing the training data, the positive sample may be determined based on the matching library (e.g., the designated address book), and then the negative sample is constructed according to the positive sample, and all samples other than the positive sample may be taken as the target negative sample, and thus, the constraint on the voice decoding path is formed to suppress the output of the unexpected voice recognition result (e.g., an incorrect voice recognition result such as “Zhang Dan” or “Zhang Han”).

By adopting the present implementation, the output of the unexpected voice recognition result (or called the incorrect voice recognition result) may be suppressed based on the constraint on the voice decoding path during the construction of the negative sample based on the positive sample, and thus the accuracy of the voice recognition is effectively improved.

In one implementation, taking the sample other than the positive sample as the target negative sample includes obtaining a data structure in a form of a node tree according to the positive sample, where each node in the node tree is an identifier corresponding to the text character that constituting the positive sample; traversing a positive path formed by the positive sample in the node tree to obtain a first path set; and determining a path other than the first path set in the node tree as a second path set which includes the target negative sample.

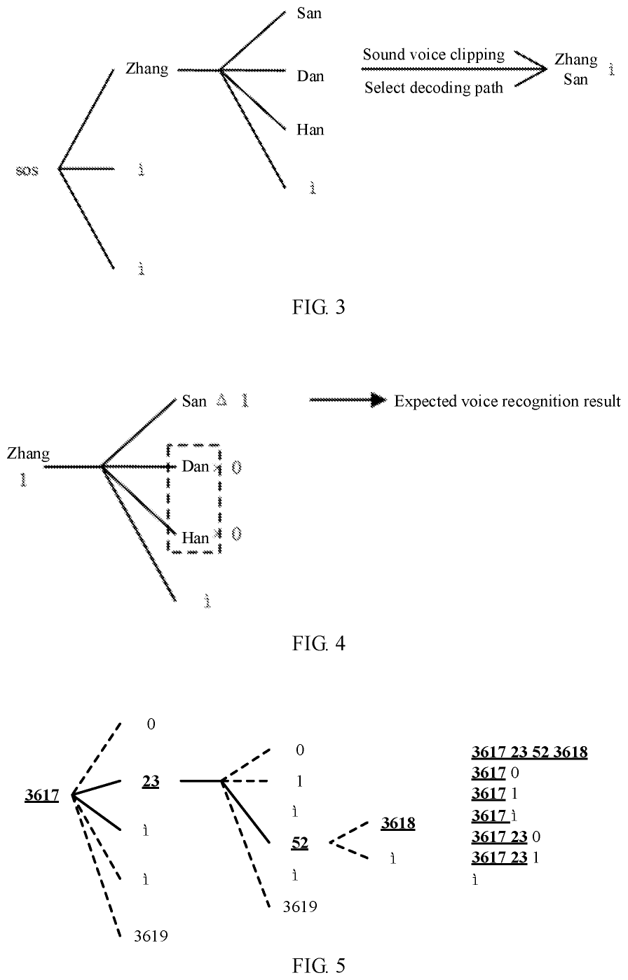

In some examples, as shown in FIG. 3, extending a voice recognition path without constraint may include the voice recognition result such as “Zhang San”, “Zhang Dan”, “Zhang Han” or the like, text of “Zhang Dan” or “Zhang Han” does not exist in the matching library (e.g., the specified address book), thereby resulting in an inaccurate voice recognition result.

In some examples, as shown in FIG. 4, voice recognition path constraint is performed on the voice recognition result such as “Zhang San”, “Zhang Dan”, “Zhang Han” or the like, with constraint, only one expected voice recognition result of “Zhang San” will be obtained, and the voice recognition result is very accurate. Where “San” is marked with 1, which is a data label of the positive sample; “Dan” and “Han” are marked with 0, which are data labels of the negative sample.

In some examples, as shown in FIG. 5, the data structure in the form of the node tree (or a prefix tree based on the positive path) includes the positive sample and the negative sample, the data structure in the form of the node tree is traversed, a path formed by a token corresponding to the positive sample is called the positive path (recorded as the first path set), a path formed by a token corresponding to the negative sample is called a negative path (recorded as the second path set), that is, the path other than the first path set is the second path set. The TABLE 1 and TABLE 2 are referred for examples of the tokens, which are not repeated here. Where tokens in the first path set are shown by the underlined numbers in FIG. 5; the other tokens are tokens in the second path set. Thus, a full positive sample may be directly generated based on the positive path. In the data structure in the form of the node tree of the positive sample, all extendable paths other than the positive path (shown by the dotted lines in FIG. 5) are negative paths, and the above target negative sample is finally obtained.

In some examples, in order to improve speed and accuracy, data dimension may be reduced through a selecting strategy of an effective negative sample. For example, an acoustic confusion matrix and a language score are used to select the effective negative sample, that is, a negative path with the lower acoustic score or language score is selected and deleted, and a remaining negative sample is used as the target negative sample, and the training data for the model training is formed accordingly.

By adopting the present implementation, the negative path other than the positive path may be obtained based on the positive path that constitutes the positive sample by traversing nodes of the data structure in the form of the node tree, so as to obtain the target negative sample. The negative sample in the negative path may also be further selected to obtain a negative sample which is more accurate and has less data volume. Constituting the training data for the model training according to the selected target negative sample and the positive sample improves model accuracy.

In one implementation, training the first voice recognition model according to the training data to obtain the second voice recognition model includes inputting the training data into an embedding layer of the first voice recognition model to convert the training data into a corresponding feature vector through the embedding layer; associating the feature vector with a history vector in an association layer of the first voice recognition model to obtain a association feature for voice recognition prediction; inputting the association feature into a full connection layer of the first voice recognition model, and then performing a binary classification process of an activation function; obtaining a loss function according to an output value obtained after the binary classification process and a target value; and training the first voice recognition model according to backpropagation of the loss function to obtain the second voice recognition model (which may be the composition model based on the neural network).

In some examples, a structure of the first voice recognition model may include the embedding layer, the association layer, the full connection layer and the activation function connecting the full connection layer. The binary classification process may be performed on output of the activation function. Where the embedding layer may be a word embedding layer; the association layer may be applied to a scenario with spatiotemporal association, it has a time cycle structure, which can well describe sequence data (e.g., temperature, traffic volume, sales volume and the like), text (e.g., a notepad, the address book), events (a shopping list, a personal behavior) with the spatiotemporal association, the association layer is not limited to a Long Short Term Memory Network (LSTM); and the activation function is not limited to a softmax function. The second voice recognition model is obtained by training the first semantic recognition model after performing the binary classification.

By adopting the present implementation, obtaining the association feature for the voice recognition prediction by converting the training data into the corresponding feature vector and associating the feature vector with the history vector may better perform the binary classification process to predict a more accurate voice recognition result during the model using.

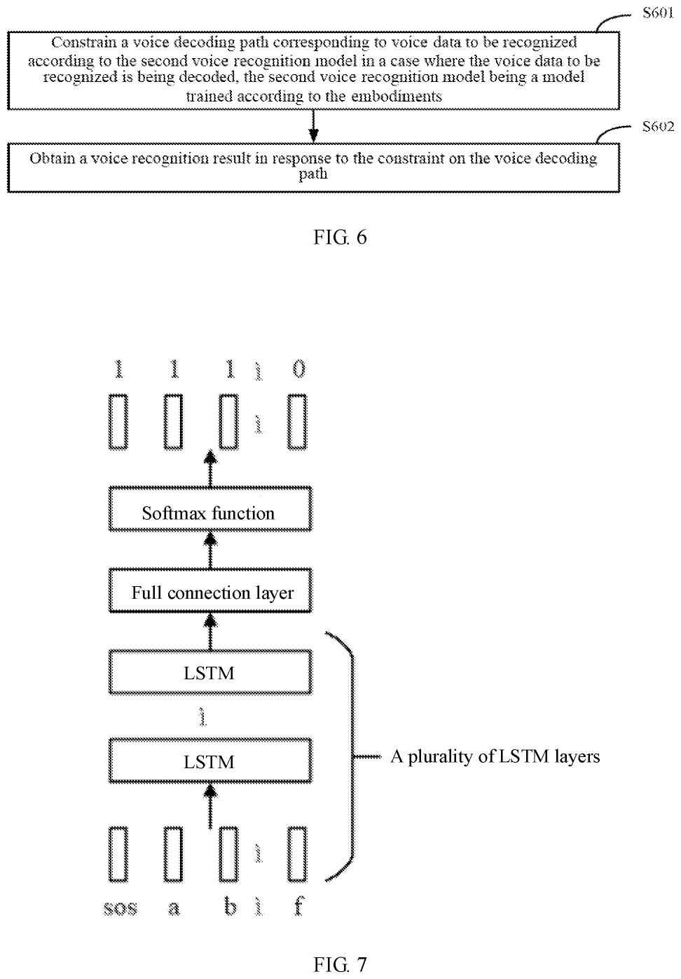

According to the embodiments of the present disclosure, a voice recognition method is provided. FIG. 6 is a flow schematic diagram of the voice recognition method according to the embodiments of the present disclosure. The method may be applied to the voice recognition apparatus. For example, the apparatus may realize the voice recognition and other processes in the case where it may be deployed in a terminal, a server or other processing devices in a single machine, multi-machines or the cluster system. Where the terminal may be a User Equipment (UE), a mobile device, a Personal Digital Assistant (PDA), a handheld device, a computing device, an on-board device, a wearable device and the like. In some possible implementations, the method may also be implemented in a manner that a processor calls a computer-readable instruction stored in a memory. As shown in FIG. 6, the method is applied to any node or electronic device (the mobile phone, the desktop, or the like) in the cluster system shown in FIG. 1, and includes S601 and S602.

In S601, a voice decoding path corresponding to voice data to be recognized is constrained according to the second voice recognition model in a case where the voice data to be recognized is being decoded, where the second voice recognition model is a model trained according to the embodiments.

In S602, a voice recognition result is obtained in response to the constraint on the voice decoding path.

In one example of S601-S602, the correct voice recognition result may be obtained according to the constraint on the voice decoding path during using of the second voice recognition model. For example, there is “Zhang San” in the address book. Since the positive sample is obtained based on matching with the address book, and the negative sample is obtained based on the positive sample, the second voice recognition model is obtained by training based on the positive sample and the negative sample, and satisfies the constraint on the voice decoding path, therefore, under the constraint on the voice decoding path, an output result of the voice recognition is expected text. For example, matching with text in the address book gets a unique voice recognition result of “Zhang San”, instead of the voice recognition result of “Zhang Dan” or “Zhang Han”.

By adopting the embodiments of the present disclosure, when the voice data to be recognized is being decoded, since the voice recognition is performed according to the constraint on the voice decoding path corresponding to the voice data to be recognized based on the second voice recognition model, a more accurate voice recognition result may be obtained in response to the constraint on the voice decoding path, thereby improving the accuracy of the voice recognition.

In one implementation, obtaining the voice recognition result in response to the constraint on the voice decoding path includes obtaining a language score corresponding to the voice data to be recognized in a case where the voice data to be recognized satisfies the constraint on the decoding path, according to the second voice recognition model; determining a target decoding path according to the language score; and obtaining the voice recognition result according to the target decoding path.

In some examples, the voice recognition method further includes obtaining an acoustic score corresponding to the voice data to be recognized, according to the acoustic model.

In some examples, determining the target decoding path according to the language score may include obtaining an evaluation value according to the language score and the acoustic score; acquiring a decoding space obtained in the case where the voice data to be recognized is being decoded, where the decoding space includes a plurality of decoding paths; and determining a decoding path with the highest evaluation value among the plurality of decoding paths as the target decoding path.

In some examples, the second voice recognition model is the composition model based on the neural network (NN), the second voice recognition model may be combined with an existing language model or replace the existing language model, to calculate the language score and the acoustic score together with the acoustic model.

By adopting the present implementation, the language score corresponding to the voice data to be recognized in the case where the voice data to be recognized satisfies the constraint on the decoding path constraint is obtained. Furthermore, the target decoding path may be determined according to the language score and the acoustic score. That is, in the decoding space including the plurality of decoding paths, the path with the highest total score of the language score and the acoustic score is taken as the target decoding path, thereby greatly improving accuracy of an output voice recognition result.

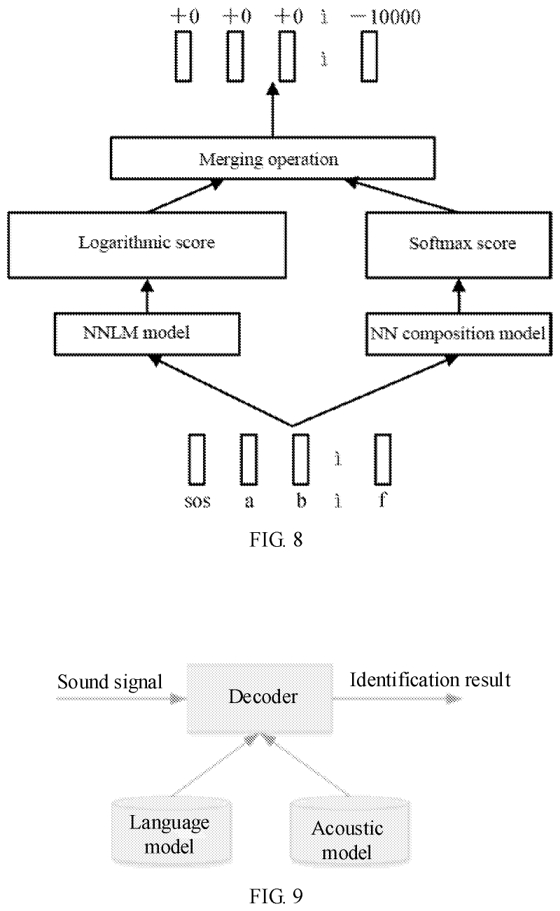

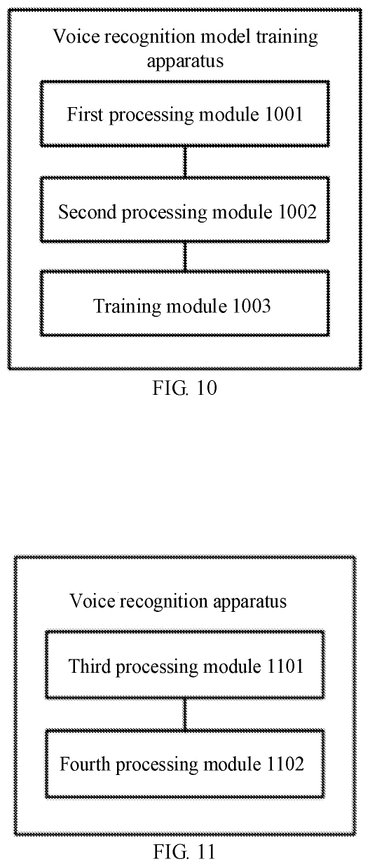

In one application example, the second voice recognition model shown in FIG. 7 is combined with a language model in a voice recognition framework shown in FIG. 9, or directly replace the language model, to decode the voice data to be recognized, so as to obtain the voice recognition result. The second voice recognition model may be the NN composition model. By combining the NN composition model with the language model, a combined language model as shown in FIG. 8 (i.e., a language model with constraint, or called a language model with composition or a NNLM with composition”) may be obtained. The NNLLM model with composition obtained by combining the NN composition model and the language model not only may perform the voice recognition accurately, but also occupies less storage space and applies more flexibly in a scenario such as offline recognition or the like.

In addition to the above language model, the voice recognition framework may also include a decoder and the acoustic model. By combining with the acoustic score and the language score, the decoder performs path search in the decoding space and converts input voice data to be recognized (i.e., an audio signal) into the correct voice recognition result under the constraint on the voice decoding path (e.g., a text content corresponding to the voice, which matches the text in the specified address book). Where the acoustic model and the language model may be optimized separately as two independent parts. The language model is more suitable for optimizing different business scenarios, for example, training a corresponding language model with text corpus in a certain field to enhance recognition performance of this scenario. Since the decoding space acquired in the case where the voice data to be recognized is being decoded (the decoding space includes the plurality of decoding paths) is obtained during decoding based on the decoder, and the decoding path with the highest evaluation value among the plurality of decoding paths is taken as the target decoding path under the constraint on the voice decoding path, the accuracy of the voice recognition is improved.

Taking the NNLM model as an example for analysis, the NNLM model, as the language model, often has better modeling ability for text and is more suitable for parallel computing. However, during collecting specific corpus to train the NNLM model, due to lack of the constraint, a path is expanded during decoding of the NNLM, as shown in FIG. 3. The decoder expands every possible path during the decoding, and finally selects the path with the highest total score of the acoustic score and the language score as the target decoding path, the obtained voice recognition result is not unique and accurate. While improving a language score of corresponding text, a language score of another unexpected text may also be improved due to similarity between the texts, imbalance of the training data and lack of model complexity. For example, the correct voice recognition result is “Zhang San”, but “Zhang Dan” and “Zhang Han” are also recognized.

It can be seen that in the case without the constraint, the decoder expands all possible decoding paths during the decoding, and lacks the constraint on the paths, resulting in outputting of the unexpected voice recognition result. Therefore, it is not enough to train one language model to improve a language score of a corresponding field, and it is also necessary to restrict the paths through other methods. The present application example is different from the above direct training of the NNLM model. By constraining the voice decoding path, the voice recognition result may be constrained within the text of the matching library (e.g., the designated address book) or a certain industry field (e.g., the communication field).

In the present application example, the mandatory constraint is provided for the voice recognition decoding path. During streaming expansion of the decoding path, the decoding path is limited to a feasible set by suppressing unexpected paths, so as to obtain an expected recognition result and greatly improve a recognition rate. A path constraint diagram is shown below. During the decoding, an extended path is scored through the composition model based on the neural network, and it is determined whether the extended path is an effective expected path by a given threshold, in order to achieve the constraint on the decoding path. This scheme mainly includes the following three parts including generation of the training sample, the model training and the model using.

### 1) Generation of the Training Sample

a. Construction of the training sample: the training samples may be divided into the positive sample and the negative sample, where the positive sample is a set of feasible paths, and the negative sample is a set of paths that need to be suppressed, that is, a set of all paths which are not positive. As shown in TABLE 3, each sample starts with the start character<sos>. The token identifier corresponding to the decoding path may be used as input of model training. The label corresponding to the positive example path may be set to 1, and the label corresponding to the negative example path may be set to 0.

TABLE 3
positive sample:

| text: | <sos> | Zhang | San |
|---|---|---|---|
| token | 3617 | 23 | 52 |
| label | 1 | 1 | 1 |

negative sample:

| text: | <sos> | Zhang | Dan |
|---|---|---|---|
| token | 3617 | 23 | 66 |
| label | 1 | 1 | 0 |

b. Generation of a full composition sample: for one given set of feasible paths, all positive and negative samples can be generated by constructing the prefix tree of the positive path. It is assumed that an input token identifier range is [0, 3619], a start character<sos> is identified as 3617, and an end symbol is 3618, the construction of the prefix tree and the generation of the sample is performed according to the positive path (3617, 23, 52, 3618), which is shown in FIG. 5. For the positive path, the full positive example sample may be directly generated by constructing a token-label data pair, and all the expandable paths other than the positive example path are the negative paths. Because once it is judged as being negative during a streaming decoding process, a subsequent path will not be expanded. Therefore, only a negative sample with the same length as the positive sample need to be trained, and all negative samples may be generated by traversing non-positive paths in each layer by using the prefix tree.
c. Generation of a composition sample under large data volume—an effective negative sample selection strategy: the above generation strategy of the full composition sample is more suitable for a set of feasible paths with relatively small sample quantity. If a given path set has a large number of positive samples, such as millions of samples, it will be difficult to traverse all negative samples, resulting in a problem of storage explosion and excessive computation.

Because in an actual decoding process, a path with lower acoustic or language scores will be clipped, this part of data may be ignored in a case where the composition model is being training, and only the effective negative sample needs to be selected. Based on this, the effective negative sample selection strategy is further proposed, which selects the negative sample by using the acoustic confusion matrix and the language score, solves a composition problem of a large sample, and significantly reduces storage space and training time, including the following i to iii.
i. Only a negative path of a confused syllable is selected, by using the acoustic confusion matrix to select top-N corresponding confuse negative sample tokens for each token of the positive path as a negative candidate.
ii. The language score is used to further filter, by using a language model that has been trained in advance to calculate the language scores of the positive sample and a candidate negative path respectively. A negative sample corresponding to a value obtained by subtracting the language score of the positive sample from the language score of the negative sample is smaller than a threshold value (that is “the language score of the negative sample—the language score of the positive sample<the threshold value”) will be further filtered.
iii. A training set is constructed by using the remaining negative samples.

### 2) Model Training

The second voice recognition model may be called the NN composition model with composition, which is abbreviated as the following NN composition model, and its network structure is shown in FIG. 7. Where a token identifier of an input training sample first gets a corresponding representation of embedding through the embedding layer, and then uses several LSTM layers to get a representation of the abstract vector with a historical memory, and finally carries out the binary classification process through the full connection layer and softmax function to perform training with a prediction sample label. Where the LSTM layers may also be replaced by other Recurrent Neural Network (RNN), or any flow neural network with a historical memory function. During the training, a weight may be shared with an underlying neural network of a language model with the same structure, or direct extending is performed based on a neural network with fixed weights of several layers of the language model, and then the training of the NN composition model is performed, which is conducive to reducing model volume and calculation.

### 3) Model Using

After the NN composition model is trained, the NN composition model is combined with the language model shown in FIG. 9 to obtain the NNLM with composition (as shown in FIG. 8) to replace the original NNLM for decoding, and thus realizing the constraint on the decoding path. Specifically, the combining is performed by implementing one merging operation, which includes the following i to ii.
i. One threshold value (which may be obtained by counting a correct rate of the positive and negative samples) is determined. If a score of the composition is greater than the threshold value, it will be judged as the positive sample, otherwise it will be judged as the negative sample.
ii. If it is judged as the positive sample, a language score of the decoding path remains unchanged (+0). If it is judged as the negative sample, one large negative score (for example, −10000) is added to the language score of the corresponding decoding path, and thus the decoding path is suppressed. In this way, it is not necessary to change the decoder and the acoustic part, but only to train one NN composition model with a given set, and combine it with the existing language model or directly replace the language model, so as to achieve the mandatory constraint on the decoding path and greatly improve the accuracy of the voice recognition result.

By adopting the present application example, a general mandatory constraint is provided for the decoding path of NNLM, which makes up an disadvantage due to lack of the path constraint during the decoding process of the original NNLM, avoids the unexpected result during a voice recognition process, and makes the decoding path be limited to a preset feasible set, thereby greatly improving the recognition effect; it not only supports a positive sample set with small amount of data, but also may support the composition with large amount of data through the effective negative sample selection strategy, thereby greatly enhancing the application scenario of the model; the model adopts a design of a NN composition model structure, shares the weight with a NN language model with similar structure, and shares the underlying neural network, thereby effectively saving the storage space and computation; during the model using, there is no need to change other parts such as the decoder and the acoustic model, the mandatory constraint on the decoding path may be realized only by training one NN composition model by using a given set and combining the trained model with the existing language model, thereby greatly improving convenience and practicability of the model.

According to the embodiments of the present disclosure, a voice recognition model training apparatus is provided. FIG. 10 is a schematic diagram of a composition structure of the voice recognition model training apparatus according to the embodiments of the present disclosure. As shown in FIG. 10, the voice recognition model training apparatus includes: a first processing module 1001 configured to construct the negative sample according to the positive sample to obtain the target negative sample for constraining the voice decoding path; a second processing module 1002 configured to obtain the training data according to the positive sample and the target negative sample; and a training module 1003 configured to train the first voice recognition model according to the training data to obtain the second voice recognition model.

In one implementation, the first processing module 1001 is configured to determine the text character in the matching library as the positive sample; and determine the sample other than the positive sample as the target negative sample.

In one implementation, the first processing module 1001 is configured to obtain the data structure in the form of the node tree according to the positive sample; where each node in the node tree is the identifier corresponding to the text character constituting the positive sample; traverse the positive path formed by the positive sample in the node tree to obtain the first path set; and determine the path other than the first path set in the node tree as the second path set which includes the target negative sample.

In one implementation, the training module 1003 is configured to input the training data into the embedding layer of the first voice recognition model to convert the training data into the corresponding feature vector through the embedding layer; associate the feature vector with the history vector in the association layer of the first voice recognition model to obtain the association feature for the voice recognition prediction; input the association feature into the full connection layer of the first voice recognition model and then perform the binary classification process of the activation function; obtain the loss function according to the output value obtained after the binary classification process and target value; and train the first voice recognition model according to the backpropagation of the loss function to obtain the second voice recognition model.

In one implementation, the second voice recognition model is the composition model based on the neural network.

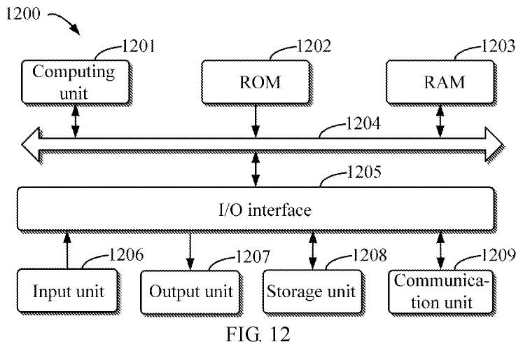

According to the embodiments of the present disclosure, a voice recognition apparatus is provided. FIG. 11 is a schematic diagram of a composition structure of the voice recognition apparatus according to the embodiments of the present disclosure. As shown in FIG. 11, the voice recognition apparatus includes: a third processing module 1101 configured to constrain the voice decoding path corresponding to the voice data to be recognized according to the second voice recognition model, in the case where the voice data to be recognized is being decoded, where the second voice recognition model is the model trained according to the embodiments; and a fourth processing module 1102 configured to obtain the voice recognition result in response to the constraint on the voice decoding path; where the voice recognition result is the text object that matches the expected text.

In one implementation, the fourth processing module 1102 is configured to obtain the language score corresponding to the voice data to be recognized in the case where the voice data to be recognized satisfies the constraint on the decoding path, according to the second voice recognition model; determine the target decoding path according to the language score; and obtain the voice recognition result according to the target decoding path.

In one implementation, the training apparatus further includes an identifying module configured to obtain the acoustic score corresponding to the voice data to be recognized according to the acoustic model.

In one implementation, the fourth processing module 1102 is configured to obtain the evaluation value according to the language score and the acoustic score; acquire the decoding space obtained in the case where the voice data to be recognized is being decoded, where the decoding space includes the plurality of decoding paths; and determine the decoding path with the highest evaluation value among the plurality of decoding paths as the target decoding path.

In the technical solution of the present disclosure, the acquisition, storage and application of the user's personal information involved are all in compliance with the provisions of relevant laws and regulations, and do not violate public order and good customs.

According to the embodiments of the present disclosure, the present disclosure also provides an electronic device, a readable storage medium and a computer program product.

FIG. 12 shows a schematic block diagram of an exemplary electronic device 1200 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar computing devices. The components shown herein, their connections and relationships, and their functions are merely examples, and are not intended to limit the present disclosure described and/or required herein.

As shown in FIG. 12, the electronic device 1200 includes a computing unit 1201 that may perform various appropriate actions and processes according to a computer program stored in a Read-Only Memory (ROM) 1202 or a computer program loaded from a storage unit 1208 into a Random Access Memory (RAM) 1203. Various programs and data required for an operation of the electronic device 1200 may also be stored in the RAM 1203. The computing unit 1201, the ROM 1202 and the RAM 1203 are connected to each other through a bus 1204. The input/output (I/O) interface 1205 is also connected to the bus 1204.

A plurality of components in the electronic device 1200 is connected to the I/O interface 1205, and includes an input unit 1206 such as a keyboard, a mouse, or the like; an output unit 1207 such as various types of displays, speakers, or the like; the storage unit 1208 such as a magnetic disk, an optical disk, or the like; and a communication unit 1209 such as a network card, a modem, a wireless communication transceiver, or the like. The communication unit 1209 allows the electronic device 1200 to exchange information/data with other devices through a computer network such as the Internet and/or various telecommunication networks.

The computing unit 1201 may be various general-purpose and/or special-purpose processing components with processing and computing capabilities. Some examples of the computing unit 1201 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1201 performs various methods and processing described above, such as the above voice recognition model training method/voice recognition method. For example, in some implementations, the above voice recognition model training method/voice recognition method may be implemented as a computer software program tangibly contained in a computer-readable medium, such as the storage unit 1208. In some examples, a part or all of the computer program may be loaded and/or installed on the electronic device 1200 via the ROM 1202 and/or the communication unit 1209. When the computer program is loaded into RAM 1203 and executed by the computing unit 1201, one or more steps of the voice recognition model training method/voice recognition method described above may be performed.

Alternatively, in other examples, the computing unit 1201 may be configured to perform the above voice recognition model training method/voice recognition method by any other suitable means (e.g., by means of firmware).

Various implementation of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof.

More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of apparatuses may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware component, or in a computing system including a front-end component (e.g., a user computer with a graphical user interface or a web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and the server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure may be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having skill in the art should understand that, various modifications, combinations, sub-combinations and substitutions may be made according to a design requirement and other factors. Any modification, equivalent replacement, improvement or the like made within the spirit and principle of the present disclosure shall be included in the protection scope of the present disclosure.

1. A voice recognition model training method, comprising:
constructing a negative sample according to a positive sample to obtain a target negative sample for constraining a voice decoding path;
obtaining training data according to the positive sample and the target negative sample; and
training a first voice recognition model according to the training data to obtain a second voice recognition model.

2. The method of claim 1, wherein constructing the negative sample according to the positive sample to obtain the target negative sample for constraining the voice decoding path comprises:
determining a text character in a matching library as the positive sample; and
determining a sample other than the positive sample as the target negative sample.

3. The method of claim 2, wherein determining the sample other than the positive sample as the target negative sample comprises:
obtaining a data structure in a form of a node tree according to the positive sample, wherein each node in the node tree is an identifier corresponding to the text character constituting the positive sample;
traversing a positive path formed by the positive sample in the node tree to obtain a first path set; and
determining a path other than the first path set in the node tree as a second path set, the second path set comprising the target negative sample.

4. The method of at claims 1-16-3, wherein training the first voice recognition model according to the training data to obtain the second voice recognition model comprises:
inputting the training data into an embedding layer of the first voice recognition model to convert the training data into a corresponding feature vector through the embedding layer;
associating the feature vector with a history vector in an association layer of the first voice recognition model to obtain an association feature for voice recognition prediction;
inputting the association feature into a full connection layer of the first voice recognition model, to perform a binary classification process of an activation function;
obtaining a loss function according to an output value obtained after the binary classification process and a target value; and
training the first voice recognition model according to backpropagation of the loss function to obtain the second voice recognition model.

5. The method of claim 4, wherein the second voice recognition model is a composition model based on a neural network.

6. A voice recognition method, comprising:
constraining a voice decoding path corresponding to voice data to be recognized according to a second voice recognition model, in a case where the voice data to be recognized is being decoded, wherein the second voice recognition model is a model trained according to the method of claim 1; and
obtaining a voice recognition result according to constraint on the voice decoding path,
wherein the voice recognition result is a text object that matches expected text.

7. The method of claim 6, wherein obtaining the voice recognition result according to the constraint on the voice decoding path comprises:
obtaining a language score corresponding to the voice data to be recognized satisfying the constraint on the decoding path, according to the second voice recognition model;
determining a target decoding path according to the language score; and
obtaining the voice recognition result according to the target decoding path.

8. The method of claim 7, further comprising:
obtaining an acoustic score corresponding to the voice data to be recognized, according to an acoustic model.

9. The method of claim 8, wherein determining the target decoding path according to the language score, comprises:
obtaining an evaluation value according to the language score and the acoustic score;
acquiring a decoding space obtained in the case where the voice data to be recognized is being decoded, wherein the decoding space comprises a plurality of decoding paths; and
determining a decoding path with a highest evaluation value among the plurality of decoding paths as the target decoding path.

10-18. (canceled)

19. An electronic device, comprising:
at least one processor; and
a memory connected in communication with the at least one processor;
wherein the memory stores an instruction executable by the at least one processor to enable the at least one processor to execute operations, comprising:
constructing a negative sample according to a positive sample to obtain a target negative sample for constraining a voice decoding path:
obtaining training data according to the positive sample and the target negative sample; and
training a first voice recognition model according to the training data to obtain a second voice recognition model.

20. A non-transitory computer-readable storage medium storing a computer instruction thereon, wherein the computer instruction is used to cause a computer to execute operations, comprising:
constructing a negative sample according to a positive sample to obtain a target negative sample for constraining a voice decoding path:
obtaining training data according to the positive sample and the target negative sample; and
training a first voice recognition model according to the training data to obtain a second voice recognition model.

21. (canceled)

22. The storage medium of claim 20, wherein constructing the negative sample according to the positive sample to obtain the target negative sample for constraining the voice decoding path comprises:
determining a text character in a matching library as the positive sample; and
determining a sample other than the positive sample as the target negative sample.

23. A non-transitory computer-readable storage medium storing a computer instruction thereon, wherein the computer instruction is used to cause a computer to execute operations, comprising:
constraining a voice decoding path corresponding to voice data to be recognized according to a second voice recognition model, in a case where the voice data to be recognized is being decoded, wherein the second voice recognition model is a model trained according to the method of claim 1; and
obtaining a voice recognition result according to constraint on the voice decoding path,
wherein the voice recognition result is a text object that matches expected text.

24. The method of claim 2, wherein training the first voice recognition model according to the training data to obtain the second voice recognition model comprises:
inputting the training data into an embedding layer of the first voice recognition model to convert the training data into a corresponding feature vector through the embedding layer;
associating the feature vector with a history vector in an association layer of the first voice recognition model to obtain an association feature for voice recognition prediction;
inputting the association feature into a full connection layer of the first voice recognition model, to perform a binary classification process of an activation function;
obtaining a loss function according to an output value obtained after the binary classification process and a target value; and
training the first voice recognition model according to backpropagation of the loss function to obtain the second voice recognition model.

25. The method of claim 24, wherein the second voice recognition model is a composition model based on a neural network.

26. The method of claim 3, wherein training the first voice recognition model according to the training data to obtain the second voice recognition model comprises:
inputting the training data into an embedding layer of the first voice recognition model to convert the training data into a corresponding feature vector through the embedding layer;
associating the feature vector with a history vector in an association layer of the first voice recognition model to obtain an association feature for voice recognition prediction;
inputting the association feature into a full connection layer of the first voice recognition model, to perform a binary classification process of an activation function;
obtaining a loss function according to an output value obtained after the binary classification process and a target value; and
training the first voice recognition model according to backpropagation of the loss function to obtain the second voice recognition model.

27. The method of claim 26, wherein the second voice recognition model is a composition model based on a neural network.

28. The electronic device of claim 19, wherein constructing the negative sample according to the positive sample to obtain the target negative sample for constraining the voice decoding path comprises:
determining a text character in a matching library as the positive sample; and
determining a sample other than the positive sample as the target negative sample.

29. An electronic device, comprising:
at least one processor; and
a memory connected in communication with the at least one processor;
wherein the memory stores an instruction executable by the at least one processor to enable the at least one processor to execute operations, comprising:
constraining a voice decoding path corresponding to voice data to be recognized according to a second voice recognition model, in a case where the voice data to be recognized is being decoded, wherein the second voice recognition model is a model trained according to the method of claim 1; and
obtaining a voice recognition result according to constraint on the voice decoding path,
wherein the voice recognition result is a text object that matches expected text.

30. The electronic device of claim 29, wherein obtaining the voice recognition result according to the constraint on the voice decoding path comprises:
obtaining a language score corresponding to the voice data to be recognized satisfying the constraint on the decoding path, according to the second voice recognition model;
determining a target decoding path according to the language score; and
obtaining the voice recognition result according to the target decoding path.
